(19) United States
(12) Patent Application Publication
(10) Pub. No.: US 2024/0100918 A1
(43) Pub. Date: Mar. 28, 2024

(54) RIGIDITY-IMPROVED VEHICLE PANEL DOOR

(71) Applicants: Hyundai Motor Company, Seoul (KR); Kia Corporation, Seoul (KR)

(72) Inventor: Je-Won CHOI, Anyang-Si (KR)

(73) Assignees: Hyundai Motor Company, Seoul (KR); Kia Corporation, Seoul (KR)

(21) Appl. No.: 18/232,277

(22) Filed: Aug. 9, 2023

(30) Foreign Application Priority Data
Sep. 27, 2022 (KR) 10-2022-0122782

(51) Int. Cl. B60J 5/04

(52) U.S. Cl. CPC B60J 5/0437; B60J 5/0431; B60J 5/0433; B60J 5/0447; B60J 5/0456; B60J 5/0484

(57) ABSTRACT

A rigidity-improved vehicle panel door includes an external panel positioned, toward the outside of a vehicle, in a door of the vehicle, an internal panel, an external edge portion of the internal panel being joined to the external panel, and the internal panel being positioned, toward the interior of the vehicle, in the door, and a rigid structure in which a plurality of support members disposed in a longitudinal direction of the vehicle are coupled to a plurality of reinforcement members to form the shape of a quadrangle, the plurality of reinforcement members being provided on a front end portion of the door and a rear end portion of the door.

### CROSS-REFERENCE TO RELATED APPLICATION

The present application claims priority to Korean Patent Application No. 10-2022-0122782, filed on Sep. 27, 2022, the entire contents of which is incorporated herein for all purposes by this reference.

### BACKGROUND OF THE PRESENT DISCLOSURE

### Field of the Present Disclosure

The present disclosure relates to a door of a vehicle in which a plurality of panels are connected to each other, and particularly to, a rigidity-improved vehicle panel door in which both end portions of each of a stabilizer and an impact beam that are provided between an external panel and an internal panel are connected to support members that are provided in a height direction on a front end portion and a rear end portion, respectively, of a door.

### Description of Related Art

Typically, as shown in FIG. 1, a door 110 through which an occupant gets in or out of a vehicle 100 is provided on the lateral side of the vehicle 100.

The door 110 is made by joining an external panel 111 and an internal panel 112 to each other. The rigidity of the door 110 is improved by including support members, such as an out belt rail 121, an impact member 122, a hinge reinforcer 124, a latch reinforcer 125, and a quadrant reinforcer 127, within the external panel 111 and the internal panel 112.

Typically, the external panel 111 and the internal panel 112 are made by performing a machining operation on a metal plate using a press mold, and the door 110 is made by joining external edge portions of the external panel 111 and the internal panel 112 to each other by performing a hemming process.

However, the external panel 111 and the internal panel 112 are formed through a large-sized press, which is suitable for a mass production, but not for a small-quantity batch production to develop types of vehicles, such as a purpose-built vehicle (PBV), that needs much time and costs to produce in a small quantity and in various types.

It takes much time and costs to manufacture the press mold, and for return on investment, the same type of vehicles has to be produced in large quantity. However, it takes much time and costs to manufacture a mold for each type of vehicles that need to be produced in a small quantity and in various types, which in turn causes an increase in manufacturing cost. Furthermore, when a small change in design, such as a change in a length of the door 110, occurs, a new mold has to be developed.

To solve the present problem, a panel for the door may be made of plastic material which is easy to manufacture, and the door may be manufactured by use of the present panel. However, there occurs a problem in that the door does not have sufficient rigidity.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a rigidity-improved vehicle panel door in which both end portions of each of a stabilizer and an impact beam are connected to support members provided in a height direction on a front end portion and a rear end portion, respectively, of a door to form a structure in the shape of a quadrangle.

To accomplish the above-mentioned object, there is provided a rigidity-improved vehicle panel door including: an external panel positioned in the door of a vehicle toward an outside of the vehicle; an internal panel positioned in the door of the vehicle toward an interior of the vehicle, wherein an external edge portion of the internal panel is joined to the external panel; and a structure including a plurality of support members and a plurality of reinforcement members, wherein the plurality of support members are disposed in a longitudinal direction of the vehicle and coupled to the plurality of reinforcement members to form a shape of a quadrangle, the plurality of reinforcement members being provided on a front end portion of the door and a rear end portion of the door.

In the rigidity-improved vehicle panel door, the support members may be a stabilizer and an impact beam that are disposed in a height direction of the vehicle in the door to be spaced from each other.

In the rigidity-improved vehicle panel door, the plurality of reinforcement members may be: a hinge upper reinforcer to which an upper hinge connecting the door to a body of the vehicle is fastened and to which a front end portion of the stabilizer is coupled; a hinge reinforcer which is positioned on a lower portion of the hinge upper reinforcer, to which a lower hinge connecting the door to the body of the vehicle is fastened under the upper hinge, and to which a front end portion of the impact beam is coupled; a latch reinforcer on which a latch is provided in a rear end portion of the door and to which a rear end portion of the stabilizer is coupled; and a latch lower reinforcer to which a rear end portion of the impact beam is coupled under the latch reinforcer.

In the rigidity-improved vehicle panel door, the hinge upper reinforcer and the hinge reinforcer may be connected to each other in the height direction of the vehicle in a front end portion of the door in the door, the latch reinforcer and the latch lower reinforcer may be connected to each other in the height direction of the vehicle in a rear end portion of the door, the stabilizer may connect the hinge upper reinforcer and the latch reinforcer to each other in a belt line in the door, and the impact beam may connect the hinge reinforcer and the latch lower reinforcer to each other under the stabilizer.

In the rigidity-improved vehicle panel door, the plurality of reinforcement members may be provided on the front end portion of the door, and the plurality of reinforcement members may be provided on a rear end portion of the door, to form a shape of a quadrangle together with the external panel and the internal panel.

In the rigidity-improved vehicle panel door, the plurality of reinforcement members may be coupled to the internal panel.

In the rigidity-improved vehicle panel door, a seating groove on which an end portion of the support members is accommodated may be formed in each of the plurality of reinforcement members.

In the rigidity-improved vehicle panel door, the stabilizer and the impact beam may be formed so that lengths thereof correspond to a length of the door.

In the rigidity-improved vehicle panel door, the hinge upper reinforcer and the latch reinforcer may extend over a predetermined distance upwards from a belt line in the door.

In the rigidity-improved vehicle panel door, the stabilizer and the impact beam may be disposed to be parallel with each other.

In the rigidity-improved vehicle panel door, a connection member connecting the stabilizer and the impact beam to each other may be provided.

In the rigidity-improved vehicle panel door, an upper end portion and a lower end portion of the connection member may be formed to surround outsides of the stabilizer and the impact beam, respectively.

In the rigidity-improved vehicle panel door, any one of the external panel and the internal panel may be made of plastic material, and the other one thereof may be made of metal material.

In the rigidity-improved vehicle panel door, the external panel may be made of plastic material, and the internal panel may be made of metal material.

In the rigidity-improved vehicle panel door with the above-described configuration according to an exemplary embodiment of the present disclosure, the panel of the door may be manufactured, as a plastic panel, using an injection mold. Thus, various types of doors may be manufactured with less development cost for less time.

Furthermore, both end portions of each of the stabilizer and the impact beam may be connected to the front end portion and the rear end portion, respectively, of the door, forming a frame structure in the shape of a quadrangle to increase the rigidity of the door.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a side view exemplarily illustrating a lateral side of a vehicle.

FIG. 2 is an exploded perspective view exemplarily illustrating a state where an external panel and an internal panel are assembled in the related art.

FIG. 3 is a schematic view exemplarily illustrating a rigid structure which is used for a rigidity-improved vehicle panel door according to an exemplary embodiment of the present disclosure.

FIG. 4 is an exploded perspective view exemplarily illustrating a state where an external panel, a rigid structure, and an internal panel are assembled into the rigidity-improved vehicle panel door according to an exemplary embodiment of the present disclosure.

FIG. 5 is a front view exemplarily illustrating a load path in the rigidity-improved vehicle panel door according to an exemplary embodiment of the present disclosure.

FIG. 6 is a front view exemplarily illustrating a state where the rigidity of a door is reinforced with the rigid structure in the shape of a quadrangle in the rigidity-improved vehicle panel door according to an exemplary embodiment of the present disclosure.

FIG. 7A is a perspective partial view exemplarily illustrating a state where a seating groove is formed in a hinge reinforcer in the rigidity-improved vehicle panel door according to an exemplary embodiment of the present disclosure.

FIG. 7B is a perspective partial view exemplarily illustrating a state where an impact beam is fastened on the seating groove in the hinge reinforcer in the rigidity-improved vehicle panel door according to an exemplary embodiment of the present disclosure.

FIG. 8 is a schematic view exemplarily illustrating a state where lengths of a stabilizer and an impact beam are increased in the rigidity-improved vehicle panel door according to an exemplary embodiment of the present disclosure.

FIG. 9A is a schematic view exemplarily illustrating a state where a connection member connecting the stabilizer and the impact beam to the rigid structure is used in the rigidity-improved vehicle panel door according to an exemplary embodiment of the present disclosure.

FIG. 9B is a cross-sectional view taken along line I-I on FIG. 9A.

FIG. 9C is a schematic view exemplarily illustrating the rigidity-improved vehicle panel door according to an exemplary embodiment of the present disclosure in which the connection member is used.

FIG. 10 is a schematic view exemplarily illustrating a structure in which a hinge upper reinforcer and a latch reinforcer extend upward in the rigidity-improved vehicle panel door according to an exemplary embodiment of the present disclosure.

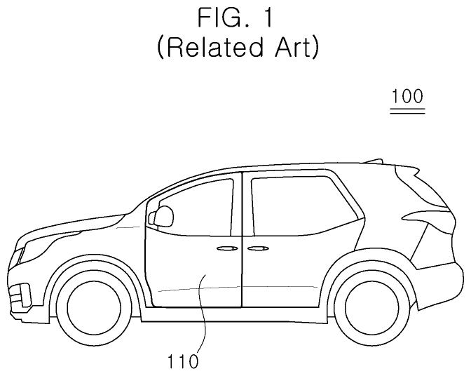

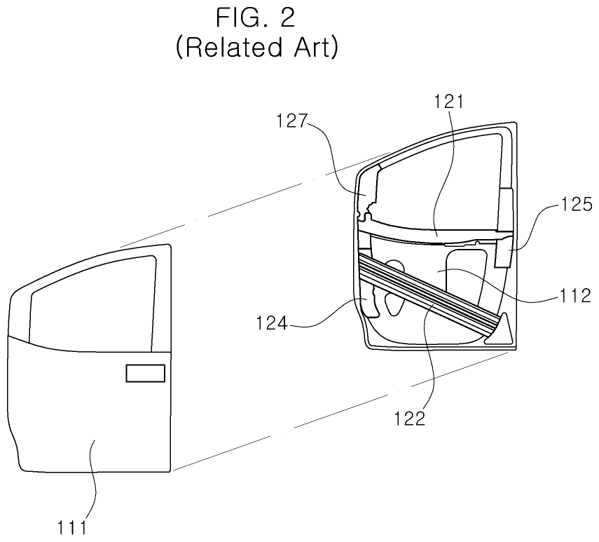

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

A rigidity-improved vehicle panel door according to an exemplary embodiment of the present disclosure will be described in detail below with reference to the accompanying drawings.

The rigidity-improved vehicle panel door according to an exemplary embodiment of the present disclosure includes: an external panel 11 positioned, toward the outside of a vehicle, in a door 10 of the vehicle; an internal panel 12, an external edge portion of the internal panel 12 being joined to the external panel 11, and the internal panel 12 being positioned, toward the interior of the vehicle, in the door 10; and a rigid structure 20 in which a plurality of support members 21 and 22 disposed in a longitudinal direction of the vehicle are coupled to a plurality of reinforcement members 23, 24, 25, and 26 to form the shape of a quadrangle, the plurality of reinforcement members 23 and 24 being provided on a front end portion of the door 10, and the plurality of reinforcement members 25 and 26 being provided on a rear end portion of the door 10.

The door 10 of the vehicle may include the external panel 11 positioned toward the outside of the vehicle, and the internal panel 12 of which external edge portion is joined to the external panel 11 is positioned toward the interior of the vehicle, in the door 10. The rigid structure 20 for reinforcing the rigidity of the door 10 may be provided between the external panel 11 and the internal panel 12.

The external panel 11 and the internal panel 12 may be formed to predetermined shapes, respectively, and when joined to each other, form the door 10.

One of the external panels 11 and the internal panel 12 is made of plastic material and the other one is made of metal material. For example, the external panel 11 is made of plastic material and the internal panel 12 is made of metal material.

Because any one of the external panels 11 and the internal panel 12 is made of plastic material, when a shape of the door 10 needs to be changed such as in vehicles that are suitable for small-quantity batch production, the shape of the door 10 may be advantageously changed by injection molding with less time and costs. However, the use of the plastic panel may decrease the rigidity of the door 10 and the plastic panel of the door 10 may be deformed and separated. The rigid structure 20 is provided to prevent these problems.

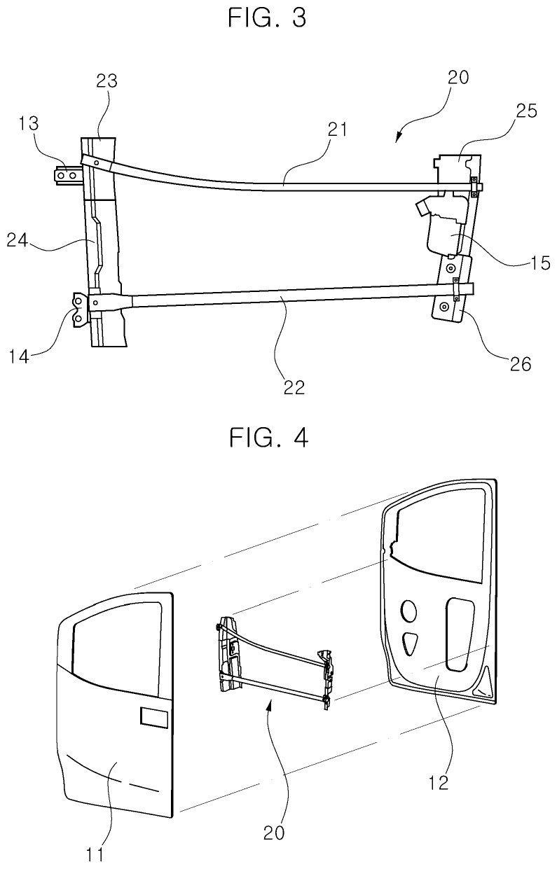

The rigid structure 20 may be formed by joining the plurality of support members 21 and 22 disposed in the longitudinal direction of the vehicle to the plurality of reinforcement members 23, 24, 25, and 26 to be spaced a distance apart away from each other to form the shape of a quadrangle as shown in FIG. 3. The plurality of reinforcement members 23 and 24 may be provided on the front end portion of the door 10, and the plurality of reinforcement members 25 and 26 are provided on the rear end portion of the door 10. The rigid structure 20 in the shape of a quadrangle, for example, in the shape of a rectangle may be coupled to the internal panel 12, and the external panel 11 may be then coupled to the internal panel 12. Thus, the door 10 may have sufficient rigidity and thus, when mounted on the vehicle, is prevented from being deformed.

The support members 21 and 22 may be implemented as a stabilizer 21 and an impact beam 22 that are disposed, in a height direction of the vehicle, in the door 10 to be spaced from each other. The stabilizer 21 may be disposed at a belt line of the door 10, and the impact beam 22 may be disposed under the stabilizer 21 to reinforce the rigidity of the door 10. A portion other than end portions of each of the stabilizer 21 and the impact beam 22 may include a closed circular or rectangular cross section.

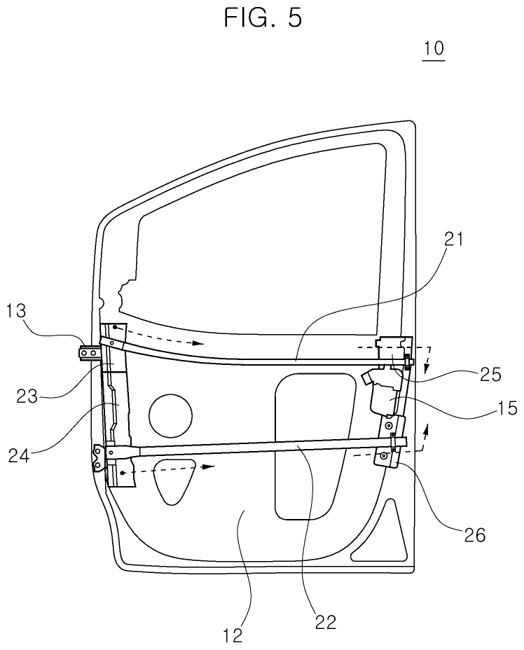

The stabilizer 21 and the impact beam 22 form a load path for transferring a load in the longitudinal direction of the vehicle in the door 10 (refer to FIG. 5).

The plurality of reinforcement members 23, 24, 25, and 26 may be implemented as a hinge upper reinforcer 23, a hinge reinforcer 24, a latch reinforcer 25, and a latch lower reinforcer 26, respectively.

An upper hinge 13 connecting the door 10 to a body of the vehicle may be fastened to the hinge upper reinforcer 23, and a front end portion of the stabilizer 21 may be coupled to the hinge upper reinforcer 23.

A lower hinge 14 which is positioned on a lower portion of the hinge upper reinforcer 23 and that connects the door 10 to the body may be fastened to the hinge reinforcer 24 under the upper hinge 13. A front end portion of the impact beam 22 may be coupled to the hinge reinforcer 24.

A latch 15 may be provided on the latch reinforcer 25 in the rear end portion of the door 10, and a rear end portion of the stabilizer 21 may be coupled to the latch reinforcer 25.

A rear end portion of the impact beam 22 may be coupled, under the latch reinforcer 25, to the latch lower reinforcer 26.

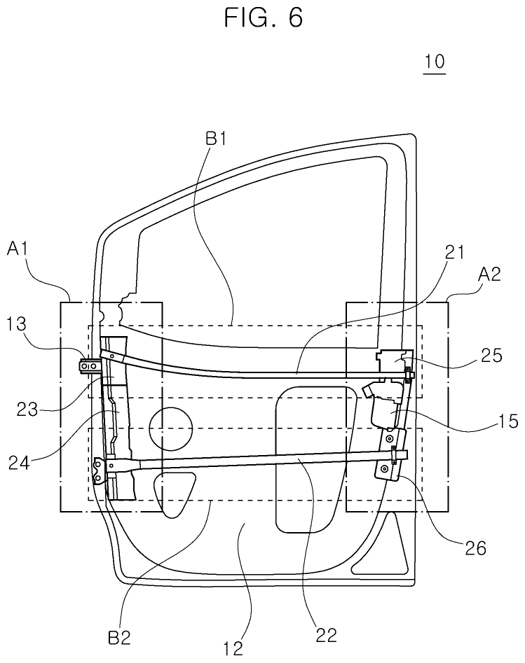

The hinge upper reinforcer 23 and the hinge reinforcer 24 may be connected to each other in the height direction of the vehicle in a front end portion of the door 10. Accordingly, the rigid structure 20 in the shape of a quadrangle may include a sub-structure which is formed in the height direction of the vehicle in the front of the door 10 (refer to A1 indicated by a dash-dotted line in FIG. 6).

The latch reinforcer 25 and the latch lower reinforcer 26 may be connected to each other, in the height direction of the vehicle, in the rear end portion of the door 10. Accordingly, the rigid structure 20 in the shape of a quadrangle may include a sub-structure which is formed in the height direction of the vehicle in the rear of the door 10 (refer to A2 indicated by a dash-dotted line in FIG. 6).

The stabilizer 21 may connect the hinge upper reinforcer 23 and the latch reinforcer 25 to each other in a belt line in the door 10. Thus, the rigid structure 20 in the shape of a quadrangle may include a sub-structure which is formed in the longitudinal direction of the vehicle in the middle portion of the door 10 (refer to B1 indicated by a dashed line in FIG. 6).

The impact beam 22 may connect the hinge reinforcer 24 and the latch lower reinforcer 26 to each other under the stabilizer 21. Thus, the rigid structure 20 in the shape of a quadrangle may include a sub-structure which is formed in the longitudinal direction of the vehicle in a lower portion of the door 10 (refer to B2 indicated by a dashed line in FIG. 6).

With the present connection structure, the rigid structure 20 may be a structure in the shape of a quadrangle, for example, in the shape of a rectangle, that includes A1, B1, A2, and B2 in FIG. 6. The stabilizer 21 and the impact beam 22 may be disposed approximately in the longitudinal direction of the vehicle, and the plurality of reinforcement members 23, 24, 25, and 26 may be disposed in the height direction of the vehicle. Thus, the rigid structure 20 includes the shape of a rectangle.

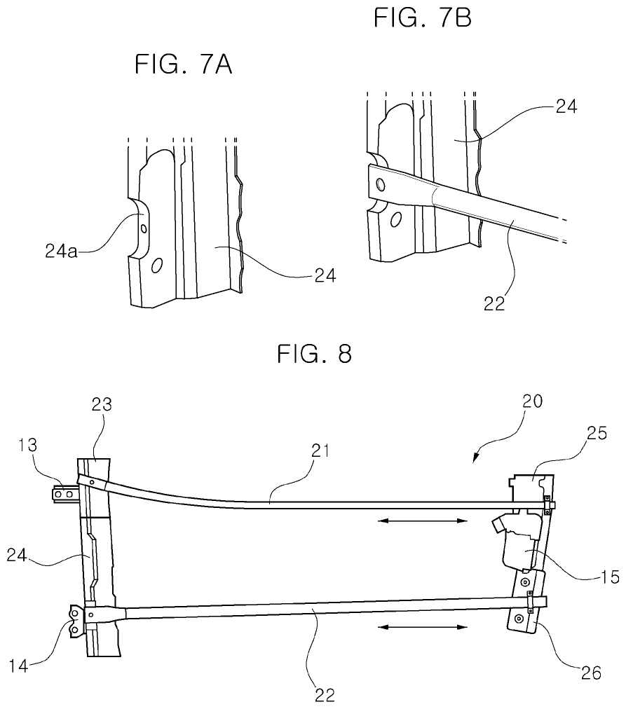

A seating groove 24a on which an end portion of each of the support members 21 and 22 is accommodated may be formed in each of the plurality of reinforcement members 23, 24, 25, and 26. An example in which the seating groove 24a is formed in the hinge reinforcer 24 is illustrated in FIG. 7A and FIG. 7B. The seating groove 24a may be also formed in the hinge reinforcer 24, the latch reinforcer 25, and the latch lower reinforcer 26.

In a case where a length of the door 10 is changed, only lengths of the support members 21 and 22 may be changed. The support members 21 and 22 may find application in various types of doors.

The stabilizer 21 and the impact beam 22 may be formed so that lengths thereof correspond to the length of the door 10. The stabilizer 21 and the impact beam 22 may be disposed to be substantially parallel with each other.

Accordingly, in a case where the length of the door 10 is changed, the lengths of the stabilizer 21 and the impact beam 22 may be changed. Thus, the stabilizer 21 and the impact beam 22 may be used for the door 10 of which length needs to be changed. FIG. 8 illustrates an example where the length of the door 10 is increased and thus where the lengths of the stabilizer 21 and the impact beam 22 may be increased.

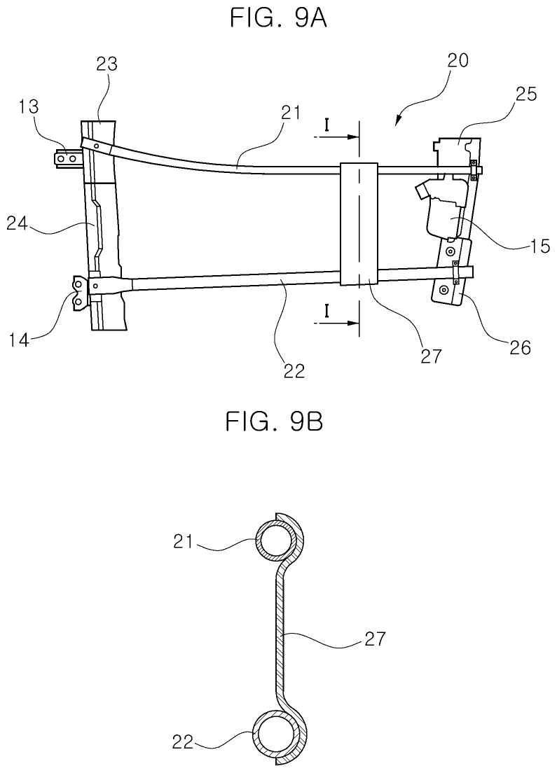

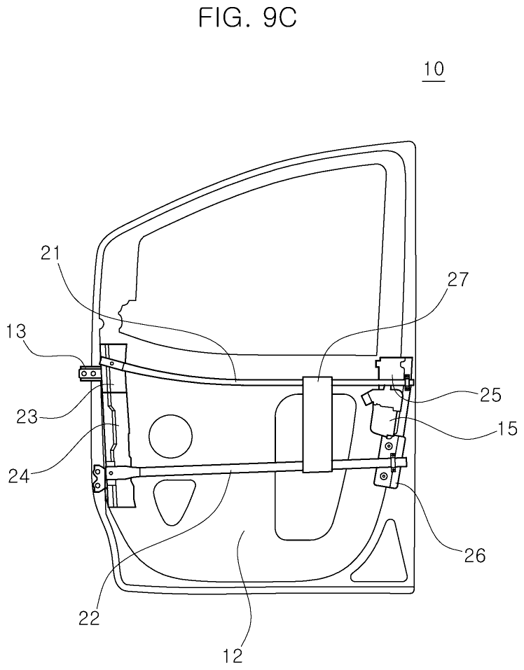

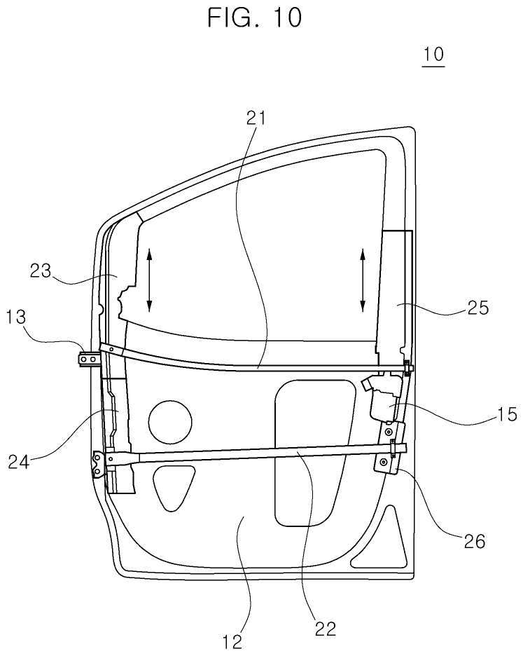

A connection member 27 connecting the stabilizer 21 and the impact beam 22 to each other may be provided, and thus the rigidity of the rigid structure 20 may be reinforced (refer to FIGS. 9A and 9C). An upper end portion and a lower end portion of the connection member 27 may surround the outsides, respectively, of the stabilizer 21 and the impact beam 22, and thus, the stabilizer 21 and the impact beam 22 may be connected to each other.

The hinge upper reinforcer 23 and the latch reinforcer 25 may extend over a predetermined distance in the height direction of the door 10 upwards from the belt line in the door 10. This extension of the hinge upper reinforcer 23 and the latch reinforcer 25 in the height direction of the vehicle may reinforce the rigidity of the door 10 (refer to FIG. 10).

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless particularly stated otherwise, a singular form may also include a plural form. The expression “at least one (or one or more) of A, B, and C” may include one or more of all combinations that may be made by combining A, B, and C.

In the exemplary embodiment of the present disclosure, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

A singular expression includes a plural expression unless the context clearly indicates otherwise.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A rigidity-improved vehicle panel door comprising:
an external panel positioned in the door of a vehicle toward an outside of the vehicle;
an internal panel positioned in the door of the vehicle toward an interior of the vehicle, wherein an external edge portion of the internal panel is joined to the external panel; and
a structure including a plurality of support members and a plurality of reinforcement members, wherein the plurality of support members are disposed in a longitudinal direction of the vehicle and coupled to the plurality of reinforcement members to form a shape of a quadrangle, the plurality of reinforcement members being provided on a front end portion of the door and a rear end portion of the door.

2. The rigidity-improved vehicle panel door of claim 1, wherein the support members include a stabilizer and an impact beam that are disposed in a height direction of the vehicle in the door to be spaced from each other.

3. The rigidity-improved vehicle panel door of claim 1, wherein the plurality of reinforcement members include:
a hinge upper reinforcer to which an upper hinge connecting the door to a body of the vehicle is fastened and to which a front end portion of the stabilizer is coupled;
a hinge reinforcer which is positioned on a lower portion of the hinge upper reinforcer, to which a lower hinge connecting the door to the body of the vehicle is fastened under the upper hinge, and to which a front end portion of the impact beam is coupled;
a latch reinforcer on which a latch is provided in the rear end portion of the door and to which a rear end portion of the stabilizer is coupled; and
a latch lower reinforcer to which a rear end portion of an impact beam is coupled under the latch reinforcer.

4. The rigidity-improved vehicle panel door of claim 3,
wherein the hinge upper reinforcer and the hinge reinforcer are connected to each other in the height direction of the vehicle in the front end portion of the door in the door,
wherein the latch reinforcer and the latch lower reinforcer are connected to each other in the height direction of the vehicle in the rear end portion of the door,
wherein the stabilizer connects the hinge upper reinforcer and the latch reinforcer to each other in a belt line in the door, and
wherein the impact beam connects the hinge reinforcer and the latch lower reinforcer to each other under the stabilizer.

5. The rigidity-improved vehicle panel door of claim 1,
wherein the plurality of reinforcement members are provided on the front end portion of the door and on the rear end portion of the door, to form a shape of a quadrangle together with the external panel and the internal panel.

6. The rigidity-improved vehicle panel door of claim 1, wherein the plurality of reinforcement members are coupled to the internal panel.

7. The rigidity-improved vehicle panel door of claim 1, wherein a seating groove on which an end portion of the support members is accommodated is formed in each of the plurality of reinforcement members.

8. The rigidity-improved vehicle panel door of claim 2, wherein the stabilizer and the impact beam are formed so that lengths thereof correspond to a length of the door.

9. The rigidity-improved vehicle panel door of claim 3, wherein the hinge upper reinforcer and the latch reinforcer extend over a predetermined distance upwards from a belt line in the door.

10. The rigidity-improved vehicle panel door of claim 2, wherein the stabilizer and the impact beam are disposed to be parallel with each other.

11. The rigidity-improved vehicle panel door of claim 2, includes a connection member connecting the stabilizer and the impact beam to each other.

12. The rigidity-improved vehicle panel door of claim 11, wherein an upper end portion and a lower end portion of the connection member are formed to surround outsides of the stabilizer and the impact beam, respectively.

13. The rigidity-improved vehicle panel door of claim 1, wherein one of the external panel and the internal panel is made of plastic material, and another thereof is made of metal material.

14. The rigidity-improved vehicle panel door of claim 13, wherein the external panel is made of plastic material, and the internal panel is made of metal material.

15. A vehicle including the rigidity-improved vehicle panel door of claim 1.

16. The vehicle of claim 15,
wherein the plurality of support members include a stabilizer and an impact beam that are disposed in a height direction of the vehicle in the door to be spaced from each other, and
wherein the plurality of reinforcement members include:
a hinge upper reinforcer to which an upper hinge connecting the door to a body of the vehicle is fastened and to which a front end portion of the stabilizer is coupled;
a hinge reinforcer which is positioned on a lower portion of the hinge upper reinforcer, to which a lower hinge connecting the door to the body of the vehicle is fastened under the upper hinge, and to which a front end portion of the impact beam is coupled;
a latch reinforcer on which a latch is provided in the rear end portion of the door and to which a rear end portion of the stabilizer is coupled; and
a latch lower reinforcer to which a rear end portion of the impact beam is coupled under the latch reinforcer.

17. The vehicle of claim 16,
wherein the hinge upper reinforcer and the hinge reinforcer are connected to each other in the height direction of the vehicle in the front end portion of the door in the door,
wherein the latch reinforcer and the latch lower reinforcer are connected to each other in the height direction of the vehicle in the rear end portion of the door,
wherein the stabilizer connects the hinge upper reinforcer and the latch reinforcer to each other in a belt line in the door, and
wherein the impact beam connects the hinge reinforcer and the latch lower reinforcer to each other under the stabilizer.

18. The vehicle of claim 17, wherein the hinge upper reinforcer and the latch reinforcer extend over a predetermined distance upwards from a belt line in the door.

19. The vehicle of claim 16, wherein a seating groove on which an end portion of the plurality of support members is accommodated is formed in each of the plurality of reinforcement members.

20. The vehicle of claim 17, further including a connection member connecting the stabilizer and the impact beam to each other.
